(19) United States
(12) Patent Application Publication
(10) Pub. No.: US 2003/0029232 A1
(43) Pub. Date: Feb. 13, 2003

(54) Coupon for measuring corrosion rates and system

(76) Inventors: Larry G. Felix, Pelham, AL (US); Heng Ban, Birmingham, AL (US); Ralph B. Dinwiddie, Knoxville, TN (US); Rafael A. Nunez, Alabaster, AL (US); Larry S. Monroe, Blountsville, AL (US); Arun K. Mehta, Los Altos, CA (US); Ian G. Wright, Oak Ridge, TN (US)

Correspondence Address: FLEHR HOHBACH TEST ALBRITTON & HERBERT LLP, Suite 3400, Four Embarcadero Center, San Francisco, CA, 94111-4187, US

(21) Appl. No.: 09/924,652

(22) Filed: Aug. 8, 2001

(51) Int. Cl. G01N 17/00

(52) U.S. Cl. 73/86

(57) ABSTRACT

A coupon for measuring the corrosion rates of metals in a hostile environment, including two or more thin-film resistive conductors formed on a substrate and positioned in close physical proximity so that they are subjected to essentially the same physical environment. One or more of the thin-film resistive conductors is directly exposed to the potentially corrosive environment while at least one of the thin-film elements is protected from the corrosive nature of the environment. The element or elements that are protected from corrosion are either shielded from the corrosive effects of the environment by the presence of a thermally thin protective layer or by being isolated from the corrosive environment while being maintained at essentially the same temperature as the elements exposed to the corrosive environment. The invention is also directed to a system for measuring the corrosion rate by measuring the change in resistance of the exposed conductor in comparison to the protected chamber.

### BRIEF DESCRIPTIONS OF THE INVENTION

This invention relates generally to a coupon for measuring corrosion rates in hostile environments, to a corrosion rate measuring system employing a probe for placing the coupon in the hostile environment, and to a system for monitoring the corrosion of said coupon when it is placed in the hostile environment.

### BACKGROUND OF THE INVENTION

Various attempts have been made to measure in real-time the corrosion rates of metals exposed to extremely high temperatures in hostile environments, such as those present in a coal-fired boiler. Specifically, the inner wall surfaces of a typical steam boiler are lined with tubes that carry water that, by virtue of the heat released within the boiler from the burning of a suitable fuel, is converted into steam. The metals from which boiler tubes are made are subject to corrosion in this environment and, over a period of time, these tubes can fail from surface corrosion. While temperatures within the boiler can exceed 3000° F., the surfaces of these tubes are typically at about 800° F.

In the past, devices have been developed that can be inserted through the boiler wall so as to expose a metal coupon to this “fireside” environment. Passive and active systems have been developed and some are commercially available. Passive systems typically expose a sample of boiler tube material to the fireside environment, while the sample is cooled and maintained at a temperature (around 800° F.) representative of the tube metal surface temperature. After a predetermined time, the probe and coupon are removed and the coupon is retrieved and analyzed to determine the rate of corrosion. In some passive systems, the coupons are prepared so that part of the surface exposed to fireside conditions is coated with a metal that is essentially inert to corrosion, while the other part of the coupon is directly exposed to the fireside environment. These types of coupons work well and have been used to determine corrosion rates. While this method will allow for the determination of a corrosion rate, it only provides this rate after being exposed for some period of time and can provide no immediate warning of failure due to a change in operating conditions or fuel.

Active systems that measure corrosion rates have been developed as well, and are commercially available. While these systems employ different methods to measure real-time rates of corrosion, all such measurements must rely on the loss of material to provide such measurements. One common approach is to measure the change in electrical resistance of a sample while it corrodes. Increasing resistance correlates to loss of material and with proper correction for those parameters that can affect the proper measurement of resistance (temperature, in particular) a corrosion rate can be determined from the accurate measurement of the change in resistance of a coupon compared to some standard. Unfortunately, these systems are typically not suitable for use in such a hostile, hot environment as that found within a boiler where it is difficult to maintain a corrosion coupon at a uniform temperature while making a measurement of the resistance of the coupon. In addition, because a macroscopic coupon will increase in resistance (corrode) at a very slow rate, very small changes in resistance must be measured in order to determine a corrosion rate. This is a considerable technical challenge, given the fireside environment.

One such active system uses an electrically isolated thin steel coupon (˜0.25 mm thick) positioned in the end of an air-cooled probe. A thermocouple is attached to an indentation in the rear side of this coupon for monitoring and controlling temperature. In the fireside environment, the coupon is maintained at 800° F. To measure the resistance of the coupon, a large current (10 Å) is periodically passed through the coupon and an external standard resistance. While the current is maintained (for about 1 second), the voltage drop across the coupon and the external standard resistor is measured and recorded. Large currents are required because, although the coupon is small (about 50 mm across), its electrical resistance is low. Changes in the resistance of the coupon over time, when compared to the external standard resistor, are used to infer the corrosion rate.

This device suffers from a number of conceptual as well as practical difficulties. Corrosion rate is derived from the rate of loss of a section of the sensor coupon as inferred from changes in its electrical resistance. This approach assumes that the sensor coupon is thinned uniformly along its entire length, which implies that the temperature of the sensor coupon is uniform throughout and/or is accurately known. It also limits the technique to measuring corrosion rates where the mode of attack is uniform; pitting attack cannot be readily measured. A major practical problem is that, because of the high, variable heat fluxes typical of fireside conditions, it is very difficult to control the temperature of the coupon surface to a preset value. The resistance of the coupon is low, whereby changes in resistance due to corrosion are small, making them difficult to measure. Even slight temperature variations result in significant changes in resistance compared to the changes due to corrosion, thus making the precise measurement of the resistance of the coupon difficult, if not impossible. The fact that the variations are dynamic rather than static represents another considerable obstacle to the success of this approach. The large currents that are employed tend to heat the standard or reference resistor as well as the coupon, and thereby add uncertainty to the measurement of resistance. The fact that the coupon must be electrically isolated from the rest of the probe increases the complexity of the device. Because the change in resistance is small, measurements are not only affected by temperature variations, but they are also affected by electrical transients.

### SUMMARY OF THE INVENTION

The present invention provides a coupon which employs two or more thin-film, high-resistance metal elements carried on a substrate with one or more elements exposed to the corrosive environment while at least one element is protected from the corrosive effects of the hostile environment to provide a reference. Being mounted in close physical proximity on the same substrate, the elements are subjected to essentially the same corrosive environment, so that the effect of varying temperature is experienced by all of the elements. The advantage of high resistance is that only a small current is required to produce a large voltage drop for the measurement of resistance. Corrosion of the thin film corrosion element yields a significant change in resistance, providing the capability of quickly measuring dynamically varying rates of corrosion.

### BRIEF DESCRIPTION OF THE DRAWINGS

The foregoing and other objects of the invention will be more clearly understood from the following description when read in conjunction with the accompanying drawings in which:

FIG. 1 is a top plan view of a coupon in accordance with the present invention, showing the corroding thin film resistance element.

FIG. 2 is a bottom plan view of the coupon of FIG. 1 showing the thin film resistance reference element.

FIG. 3 is a sectional view taken along the line 3-3 of FIG. 1.

FIG. 4 is a top plan view of a coupon in accordance with another embodiment of the invention.

FIG. 5 is a sectional view along the line 5-5 of FIG. 4.

FIG. 6 is a top plan view of a coupon in accordance with still another embodiment of the present invention.

FIG. 7 is a top plan view of a coupon in accordance with a further embodiment of the present invention.

FIG. 8 is a sectional view showing a coupon mounted on a corrosion probe.

FIG. 9 is a sectional view showing a coupon mounted on a hollow bolt.

FIG. 10 is a circuit diagram of a circuit for measuring the change in resistance due to corrosion.

FIG. 11 is a curve showing the change in resistance due to corrosion, illustrating two corrosion rates.

### DESCRIPTION OF THE PREFERRED EMBODIMENT

Thin film corrosion elements of constant cross-section are deposited on a substrate that is electrically non-conductive or is treated to have an electrically nonconductive surface film. Small rates of corrosion of the film exposed to the hostile environment will yield a large change in its resistance.

The thin film corrosion elements are fabricated in one of two ways, either of which will withstand the fireside environment. In either approach, thin films of the metal of interest (for instance, iron) are sputtered or evaporated onto electrically insulating substrates. In one embodiment, two patterns are applied or deposited onto a substrate. One pattern is covered by a film of inert material, whereby it is protected from the corrosive environment, while the other thin film pattern is exposed to the corrosive environment. The two thin patterns are positioned so that they will be subjected to substantially the same temperature environment.

In another embodiment, the patterns are deposited on opposite sides of a thin substrate, whereby only one pattern is exposed to the hostile environment. The side of the coupon not exposed to the hostile environment may or may not need to be protected by a protective layer. In another embodiment, both patterns are on the same side of the substrate and overlying one another, with one pattern protected by a corrosion-resistant layer and insulated from the top exposed pattern.

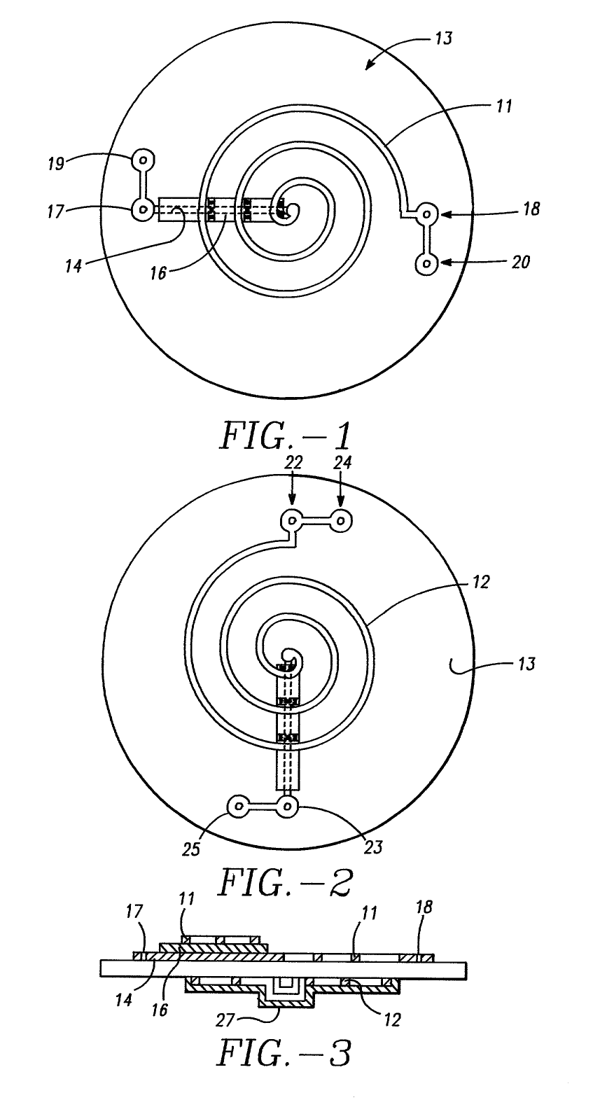

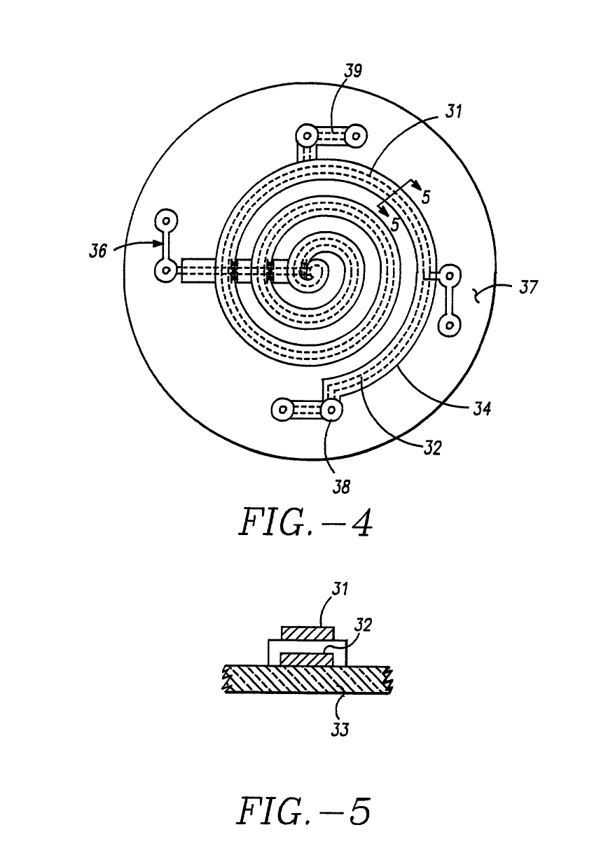

Referring now to FIGS. 1-3, a coupon which includes elongated thin metal conductors 11 and 12 on opposite surfaces of a disc-shaped substrate 13 is shown. The substrate may comprise a thin wafer of beryllium oxide ceramic (beryllia). While any suitable ceramic can be adapted, it appears that beryllia offers the best properties because it is an excellent electrical insulator, is easily formed into thin sheets, is chemically inert in a fireside environment, has a heat conductivity near that of steel, and has a coefficient of thermal expansion which is high enough to preclude the spalling or peeling off of films sputtered onto its surface.

Another suitable substrate is the metal alloy FeCrAlY. This alloy has the desired property that when it is heated to 2012° F. (1100° C.) in air and maintained at that temperature for a period of time, a very adherent, electrically-insulating, hard, thin film of alpha-alumina grows on its surface. Other substrates, such as glass, can be used for lower temperature applications.

The thin metal conductive elements can be formed employing deposition techniques known in the semiconductor processing art. Thin film elements having substantially uniform cross-sectional areas can be formed by masking the surface of the substrate 13 by photolithographic methods, forming openings in the mask conforming to the desired configuration of the resistive elements, and then depositing by sputtering or other deposition technique a thin film of metal onto the surface of the mask. The metal adheres to the substrate in the windows or openings. When metal of desired thickness has been deposited, the deposition process is terminated, and the mask is removed by dissolving or etching, leaving the conductive pattern.

In the example of FIG. 1, thin film spiral metal conductors 11 and 12 are formed. The connection to the center of the spiral is made by masking and depositing metal to form a radial conductive lead 14. This is followed by masking and depositing a suitable oxide film 16 over the conductor to protect the conductive lead 14 from the hostile environment, and electrically insulate the lead from the overlying spiral conductor to which it is connected. Finally, by masking and depositing metal, the spiral is formed with voltage and current connections 17, 18 and 19, 20, respectively. A similar process is carried out to form spiral conductor 12 on the underside of the substrate directly opposite the upper spiral. The spiral includes voltage and current connectors 22, 23 and 24, 25, respectively. Since the substrate is thermally thin, the two resistive elements 11 and 12 are exposed to substantially the same thermal environment. The conductive film on the lower surface is preferably overcoated with a protective sputtered-on oxide layer 27 to prevent corrosion.

The details of which metal to use for the thin film sensor are thought to be readily resolvable, even though it is unlikely that deposition techniques can produce the exact alloy composition (or microstructure) used for the actual components for which the corrosion rate data are desired. There is, however, sufficient understanding of the corrosion behavior of various alloy systems to allow correlation to be made between the corrosion rate of, for instance, pure iron (which could be deposited on a probe) and carbon steels that are commonly used for heat transfer tubing which is subjected to the hostile environment. Electrical connection can be made to the terminals 17, 18 and 19, 20 at the end of the spiral 11 through the substrate by providing holes in the substrate into which conductive material is deposited during the deposition of the thin film conductor. Electrical connections can be directly made to the terminals 22, 23 and 24, 25 on the spiral 12 formed on the other surface of the wafer.

In a more complex embodiment, FIGS. 4 and 5, the two conductive elements 31 and 32, are on the same side of an appropriate substrate material 33. They are separated by a protective oxide layer 34 that keeps the underside element 32 from experiencing corrosion. The element is subjected to exactly the same thermal environment as the upper corroding element 31. As in FIG. 1, masking is used to create a pathway underneath each spiral. The essential technology is that of multilayer deposition by sputtering through multiple masks. The spiral 32 is formed on the upper surface of the substrate 33, as in FIG. 1. The protective oxide layer 34 is then formed. The upper element 31 is formed after rotating the substrate by 90° to allow for proper placement of the connection pads 36, 37 and 38, 39 for current and voltage measurement. The lower, noncorroding spiral is overcoated with the protective sputtered-on oxide layer 34. The idea is that the non-corroding layer is placed directly underneath the reacting layer on the same side of the substrate as the corroding layer. Thus, the substrate need not be thin to maintain substantially equal temperatures on the two sides, because both resistive elements will experience the same thermal environment.

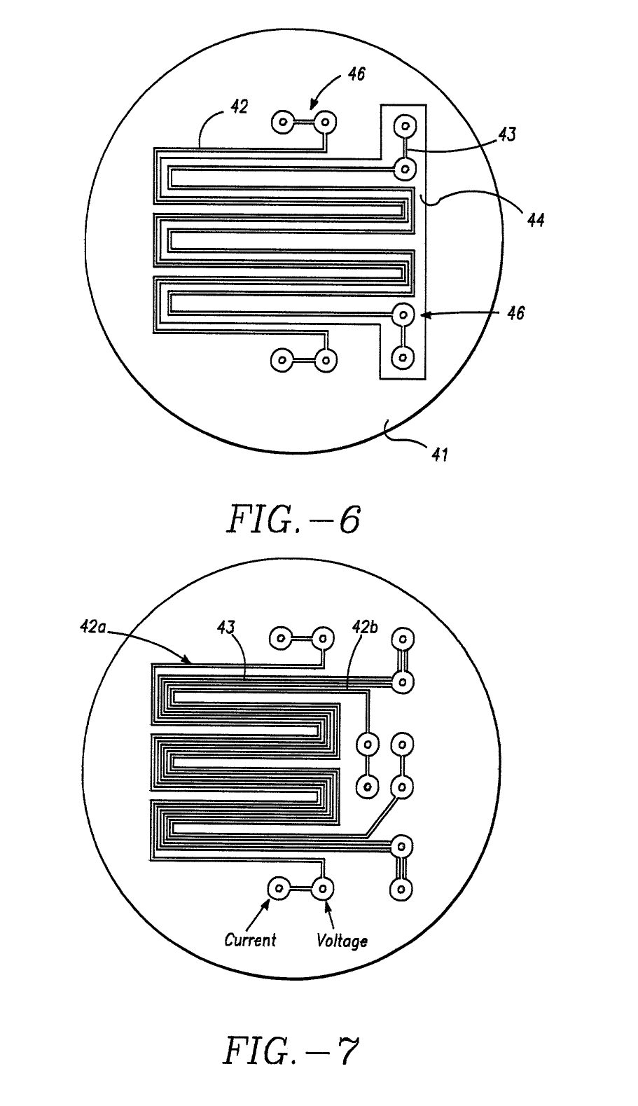

FIG. 6 illustrates another configuration for a single-sided corroding and noncorroding coupon. The layouts do not explicitly require the layers to be stacked upon one another, rather the concept is that they are so close throughout their paths that they experience substantially the same thermal environment.

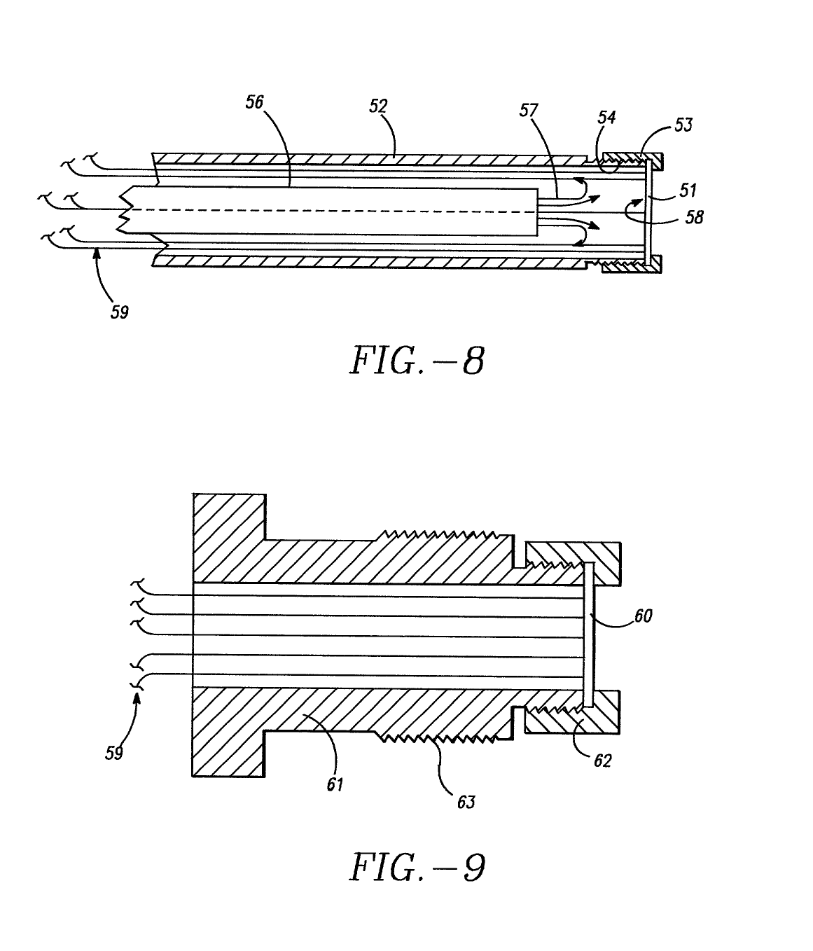

The coupon includes a substrate 41 on which are formed metal elements 42 and 43. The element 43 is protected by an oxide film 44. The ends of the elements include voltage and current connection pads 46. FIG. 7 shows an embodiment including two corroding elements 42a and 42b laid down in connection with one protected element 43, thereby providing two real-time measurements of corrosion rate, while being referred to a single non-corroding protective metal layer. In all embodiments, connections to the various metal layers or elements are provided by depositing metal conductive material into holes formed in the substrate or by leads extending through the holes. If the substrate is a metal substrate which has been treated to form protective oxide film, holes are formed before oxidation so that an insulating oxide covers the walls of the holes. Metal leads can extend through the holes without shorting to the metal substrate. It should be apparent that other configurations for the thin film elements may be employed. The elements should provide a continuous high resistance path in which there is a substantial change in resistance as the element corrodes.

Referring to FIG. 8, a coupon 51, formed in accordance with one of the embodiments discussed above, is secured to the end of the hollow probe 52 by means of a ring 53 which is threaded onto the end 54 of the hollow probe. A concentric tube 56 is suitably mounted within the probe 52, and provides for directing the flow of cooling air 57 through the tube 56 to the underside 57 of the coupon. The flow of air is controlled to maintain the coupon at substantially the same temperature as the metal whose corrosion is to be measured. Leads 59 are shown connected to the metal films of the coupon.

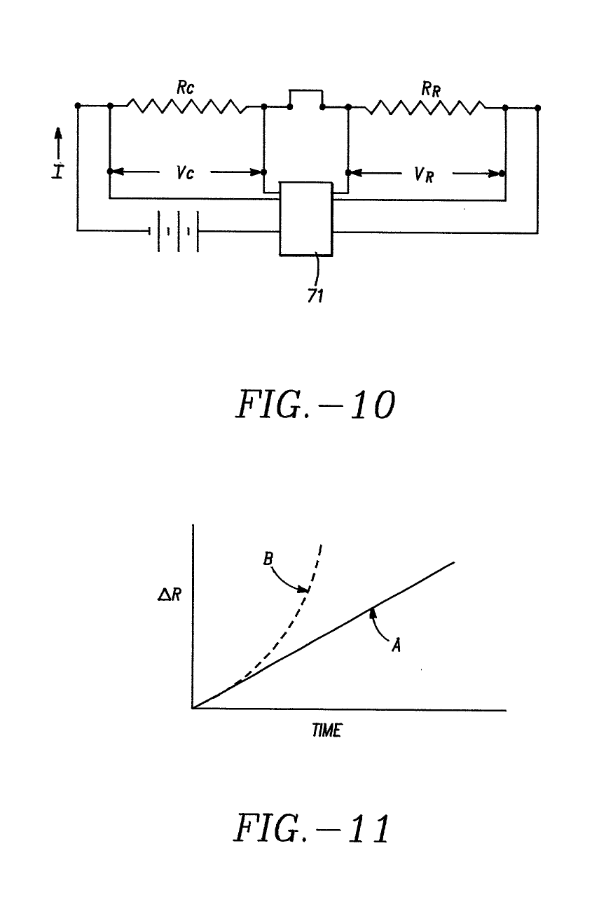

In another embodiment, FIG. 9, a coupon 60 can be mounted at the end of a bolt 61 by a ring 62 threaded onto the end of the bolt. The bolt can be directly threaded by threads 63 into the wall of the boiler, whereby it is maintained at substantially the same temperature as the boiler tubes. There would be no necessity for cooling.

FIG. 10 is a diagram of a circuit suitable for measuring the change in resistance of the corrosion element. R_{C} represents the resistance of the corroding element while R_{R} represents the resistance of the reference elements. A current I is caused to flow through the two elements. The voltage V_{C} and V_{R} across the two elements is applied to a circuit 71 configured to receive the current I and the voltages V_{C} and V_{R} and calculate the change in resistance ΔR due to corrosion, as follows:

$$Δ R = {R}_{C} - {R}_{R} = \frac{{V}_{C}}{I} - \frac{{V}_{R}}{I} .$$

It is apparent that other means of measuring the change in resistance using alternating or dc current are available. For example, measuring the voltage drop across the resistive elements with a volt meter or lock-in amplifier.

FIG. 11 schematically illustrates the change in resistance with corrosion. Curve A shows a constant corrosion rate and curve B a corrosion rate which is increasing rapidly, signaling a potentially dangerous condition. The actual amount of corrosion can be easily calculated knowing the composition of the thin film material and the boiler tube material.

As described above, the material selected for the corrosion element should preferably be one that corrodes at substantially the same rate as the tubing or other component which is being monitored or in the alternative one for which a relationship can be calculated. The circuit can be calibrated to provide an indication of the amount of corrosion.

The corrosion elements can be made very thin and long to provide a high resistance whereby corrosion will have a large effect upon the resistance. This, coupled with the fact that the reference and corrosion elements are in close proximity, whereby they are subjected to the same temperature, provides a highly sensitive corrosion measuring coupon and system.

The foregoing descriptions of specific embodiments of the present invention are presented for the purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A coupon used for measuring corrosion rates of material exposed to hostile environment comprising:
a substrate,
a first thin film resistive element carried on such substrate and exposed to the hostile environment, and
a second thin film resistive element carried by said substrate and shielded from the hostile environment, said first and second thin film resistive elements positioned so that they are subjected to essentially the same temperature.

2. A coupon as in claim 1 in which said thin metal elements are composed of a material which has substantially the same resistance before being subjected to a corrosive environment.

3. A coupon as in claims 1 or 2 in which the substrate is an insulator.

4. A coupon in as in claim 1 in which the substrate is a ceramic.

5. A coupon as in claim 4 in which the ceramic is beryllium oxide.

6. A coupon as in claim 1 in which the substrate is a metal with a insulating surface oxide film.

7. A coupon as in claim 6 in which the substrate is FeCrAlY.

8. A coupon as in claims 1 or 2 in which said first and second resistive elements are on the same side of the substrate.

9. A coupon as in claim 2 in which said material forming the thin films is a metal or metal alloy.

10. A coupon as in claims 1 or 2 in which said first and second resistive elements are on opposite sides of the substrate and the substrate is thermally thin.

11. A system for measuring the corrosion rate of metals in a hostile environment comprising a coupon including:
a substrate,
a corrosive thin film metal resistive element carried on said substrate for exposure to the hostile environment, and
a second reference thin film metal resistive element carried on substrate shielded from the hostile environment, said first and second thin film elements positioned on said substrate to be subjected to essentially the same temperature,
means for driving a current I through said first and second thin film metal elements,
means for measuring the voltage V_{C} generated across said corrosive thin film metal elements and the voltage V_{R} generated across said reference thin film element by the current flowing therethrough, and
means for processing said current and voltages to provide a measure of change in resistance of the corrosive thin film metal element.

12. A system as in claim 11 including means for continuously receiving resistance difference to indicate the progression of corrosion.

13. A system as in claim 11 in which said thin film metal elements are deposited so as to have essentially the same resistance before corrosion of the corrosive element.

14. A coupon for use in measuring the corrosion rate of metals exposed to a high-temperature hostile environment comprising:
a substrate,
a first thin narrow elongated strip of metal or metal alloy adapted to be exposed to the hostile environment carried by said substrate,
a second thin narrow elongated strip of the same metal or metal alloy as the first carried by the substrate and shielded from the hostile environment but exposed to the substantially the same high temperature as the first elongated strip of metal or metal alloy.

15. A coupon as in claim 14 in which the substrate is thin and the first and second elongated strips are on opposite faces of the substrate whereby the second elongated strip is shielded from the hostile environment by the substrate.

16. A coupon as in claim 15 wherein the second elongated strip is further shielded by an oxide film on its exposed surface.

17. A coupon as in claim 14 in which said first and second elongated strips are on the same face of the substrate and the exposed face of the second strip is shielded from the hostile environment by an oxide film.

18. A coupon as in claim 17 in which the first and second elongated strips extend adjacent to one another in close proximity.

19. A coupon as in claim 17 in which said first elongated strip overlies the second strip and is insulated therefrom by an oxide film.

20. A coupon as in any of claims 14, 15, 16, 17, 18 or 19 in which the substrate is a ceramic.

21. A coupon as in any of claims 14, 15, 16, 17, 18 or 19 in which said substrate is a metal with an oxide insulating and protective film.

22. A coupon as in claim 15 including a third elongated strip adapted to be exposed to the hostile environment adjacent the other side of the first elongated strip and exposed to substantially the same temperature.

23. A coupon as in claim 18 or 19 in which the elongates strips spiral.

24. A coupon as in claim 18 or 19 in which the strips zig-zag.
